(19) United States
(12) Patent Application Publication
(10) Pub. No.: US 2021/0320731 A1
(43) Pub. Date: Oct. 14, 2021

(54) SYSTEM AND A METHOD FOR DETERMINING LOCATION OF AN ASSET

(71) Applicant: Carrier Corporation, Palm Beach Gardens, FL (US)

(72) Inventors: Ramesh Babu, Hyderabad (IN); Sriram Atluri, Hyderabad (IN)

(21) Appl. No.: 17/121,366

(22) Filed: Dec. 14, 2020

(30) Foreign Application Priority Data
Apr. 13, 2020 (IN) 202011015958

(51) Int. Cl. H04B 17/27; H04B 17/318; G06F 1/16; H04W 4/80

(52) U.S. Cl. CPC H04B 17/27; H04W 4/80; G06F 1/163; H04B 17/318

(57) ABSTRACT

A system and a method for determining location of an asset. A method includes receiving a request from a user for locating an asset and transmitting the signal to a plurality of sensors. Each of the plurality of sensors configured to transmit a beacon for locating the asset and to receive a communication in response to the transmitted beacon from a module coupled with the asset. The method further includes receiving the communication from each of the plurality of sensors for evaluation and determining the location of the asset coupled with the module by evaluating the communication received from each of the plurality of sensors.

### CROSS-REFERENCE TO RELATED APPLICATIONS

This application claims priority to Indian Patent Application No. 202011015958, filed Apr. 13, 2020, the contents of which are incorporated by reference herein in their entirety.

### TECHNICAL FIELD

The present invention generally relates to asset/s tracking. More particularly, the invention relates to a system and a method for determining location of an asset inside premises.

### BACKGROUND

In the daily routine of life, people use several assets such as phones, watches, laptops, home keys, car keys etc. At times, a user may keep an asset at a particular place in a home or a building and may later forget the place where the asset has been kept. In such a situation, the user may take several minutes or at times even hours to manually locate/find that asset. The user may have some anxious moments while locating the asset. Even after spending considerable amount of time looking for the asset, the user may still not find it. This manual way of looking for an asset leads to a wastage of time, anxiety, and frustration.

Existing solutions for finding an asset use Global Positioning Systems (GPS) technology in homes or buildings. However, such solutions fail and are not effective because position of an asset shown using the GPS does not point to or specify any particular room in the building where the asset is present or any location of the asset at a granular level inside the building. Other existing solutions involve usage of bluetooth beacon technology which enables a tracking device attached with the asset to produce an audible sound. The audible sound would help the user to locate the asset. But, the audible sound cannot always be tracked in case of a noisy environment, closed doors facilities or large commercial offices. This kind of solution requires a silent/noise-free environment for finding the asset and works well in small areas. Moreover, the existing solutions are expensive since dedicated location based hardware and associated circuits are required merely for finding the assets.

In view of the afore-mentioned problems in the existing solutions, there is a need of a cost effective solution for locating an asset in a home or a building. There is also a requirement of an effective solution for locating the asset in any kind of noisy environment. In order to solve the problems in the existing solutions, a system and a method are disclosed.

### SUMMARY

Various embodiments of the invention describe a system for determining location of an asset. The system comprises a device, a plurality of sensors and an asset. The device is configured to receive a request from a user to locate an asset inside a premises. Also, the device is further configured to transmit a signal for locating the asset. The plurality of sensors are communicably coupled with the device and are configured to receive the signal from the device. The plurality of sensors are also configured to transmit a beacon in response to the received signal and to receive a communication in response to the transmitted beacon. The plurality of sensors are further configured to transmit the communication to the device for evaluation. The asset is coupled with a module configured to receive the at least one beacon from the plurality of sensors and transmit the communication back to a corresponding sensor of the at least one beacon. The device is further configured to evaluate the communication to determine the location of the asset.

In an embodiment of the invention, the request comprises receiving input from the user via a user interface.

In a different embodiment of the invention, the device is a thermostat and the plurality of sensors correspond to zone sensors installed inside the premises.

In another embodiment of the invention, the input from the user comprises unique information associated with the asset.

In yet another embodiment of the invention, the transmission of the signal from the device comprises a unique identifier associated with the asset and the unique identifier is derived from the unique information.

In another embodiment of the invention, the beacon transmitted by each of the plurality of sensors comprises the unique identifier associated with the asset. Also, the at least one beacon of the plurality of beacons is received by the module associated with the asset.

In yet another embodiment of the invention, the module verifies the unique identifier on receiving the at least one beacon and further sends the communication to the corresponding sensor of the at least one beacon.

In still another embodiment of the invention, the communication received by each of the corresponding sensors comprises a received signal strength indicator (RSSI) value.

In a different embodiment of the invention, the RSSI value received from each of the corresponding sensors and predetermined location of each of the corresponding sensors is used by the device to determine location of the asset.

In an embodiment of the invention, the module coupled with the asset is a tile tracking device, a pebble tracking device, a bluetooth module or a bluetooth module coupled with a smart phone or a smart watch.

Various embodiments of the invention describe a method for determining location of an asset. The method comprises steps of receiving a request from a user to locate an asset inside a premises. Also, the device is configured to transmit a signal for locating the asset. The method also comprises steps of transmitting the signal to a plurality of sensors communicably coupled with the device. Each of the plurality of sensors are configured to transmit a beacon for locating the asset and to receive a communication in response to the transmitted beacon. The asset is coupled with a module to receive the at least one beacon from the plurality of sensors and transmitting the communication back to a corresponding sensor of the at least one beacon. The method further comprises steps of receiving the communication from each of the plurality of sensors for evaluation and determining the location of the asset coupled with the module by evaluating the communication received from each of the plurality of sensors.

In an embodiment of the invention, the request comprises receiving input from the user via a user interface.

In a different embodiment of the invention, the device is a thermostat and the plurality of sensors correspond to zone sensors installed inside the premises.

In an embodiment of the invention, the input from the user comprises unique information associated with the asset.

In another embodiment of the invention, the transmission of the signal from the device comprises a unique identifier associated with the asset. Also, the unique identifier is derived from the unique information.

In yet another embodiment of the invention, the beacon transmitted by each of the plurality of sensors comprises the unique identifier associated with the asset. Further, the at least one beacon of the plurality of beacons is received by the module associated with the asset.

In another embodiment of the invention, the communication received by each of the corresponding sensors comprises RSSI value. Further, the RSSI value received from each of the corresponding sensors and predetermined location of each of the corresponding sensors is used by the device to determine location of the asset.

In an embodiment of the invention, the module verifies the unique identifier on receiving the at least one beacon and further sends the communication to the corresponding sensor of the at least one beacon.

In another embodiment of the invention, the module coupled with the asset is a tile tracking device, a pebble tracking device, a bluetooth module or a bluetooth module with a smart phone or a smart watch.

In another different embodiment of the invention, a computer readable medium is disclosed for determining location of an asset. The computer readable medium comprises one or more processors and a memory is coupled to the one or more processors, the memory stores instructions executed by the one or more processors. The one or more processors are configured to receive a request from a user to locate an asset inside a premises. Also, the device is configured to transmit a signal for locating the asset. The one or more processors are also configured to transmit the signal to a plurality of sensors communicably coupled with the device. Further, each of the plurality of sensors are configured to transmit a beacon for locating the asset and to receive a communication in response to each of the transmitted beacon. Moreover, the asset is coupled with a module to receive the at least one beacon from the plurality of sensors and transmit the communication back to a corresponding sensor of the at least one beacon. The one or more processors are further configured to receive the communication from each of the beacon for evaluation and to determine the location of the asset coupled with the module by evaluating the communication received from each of the plurality of sensors.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1 depicts an exemplary system architecture according to various exemplary embodiments of the invention.

FIG. 2 depicts block diagram of different components of an exemplary device according to an exemplary embodiment of the invention.

FIG. 3 depicts an exemplary flowchart illustrating a method to perform the invention according to an exemplary embodiment of the invention.

Corresponding reference numerals indicate corresponding parts throughout the drawings.

### DETAILED DESCRIPTION

Described herein is a technology with a system and a method for locating an asset in a premises and thereby, determining location of the asset. The asset may be present inside a room of a premises and a user of the asset may raise a request to locate the asset using a device. Further, the device may also be present inside the premises and may receive the request from the user to locate the asset. The device may then transmit a signal to a plurality of sensors present inside the premises and in response to the signal, the plurality of sensors may transmit at least one beacon to the asset. In response to the beacon received from the plurality of sensors, a module coupled with the asset may transmit a communication to the plurality of sensors. In an exemplary embodiment, the communication from the module may comprise a received signal strength indicator (RSSI) value. Furthermore, the plurality of sensors may transmit the communication to the device for evaluation to determine a location of the asset.

As used herein, the asset may be removably coupled with a module, wherein the module may have a capability to communicate with the plurality of sensors over a network. In an exemplary embodiment, the module coupled with the asset may be a tracking device. Further, the asset may be a phone, a watch, a laptop, a home key, a car key, car, an accessory, a wearable device, a bottle, a box or any such item as understood by a person skilled in the art.

As used herein, the device may be installed inside a premises and may have a capability to communicate with the plurality of sensors over a network. Further, the device enables a user to raise a request for locating the asset or determining the location of the asset. In an exemplary embodiment, the device may be a thermostat.

As used herein, the plurality of sensors may be zone sensors installed inside the premises. The sensors may be temperature sensors, fire sensors, CO₂ sensors, pressure sensors and or any such sensors that is obvious to a person skilled in the art. In another exemplary embodiment, the plurality of sensors may be thermostats with capability of sensing temperature.

As used herein, the premises may be a home or a building where the device and the plurality of sensors may be installed.

As used herein, the network may refer to a wired network, a mesh network, a cellular network (such as Global System for Mobile (GSM) network, a Long-Term Evolution (LTE) network, a code-division multiple access (CDMA) network, a narrow-band internet of thing (NB-IoT) technique or category M1 technique)), a short-range network (a WiFi network, a ZigBee network, a bluetooth network, or a near-field communication technique) or any such network/technique that is known in the art.

Throughout the specification, reference numeral 108 depicts different sensors. Each of the reference numerals 108A-108D may be considered as a separate sensor.

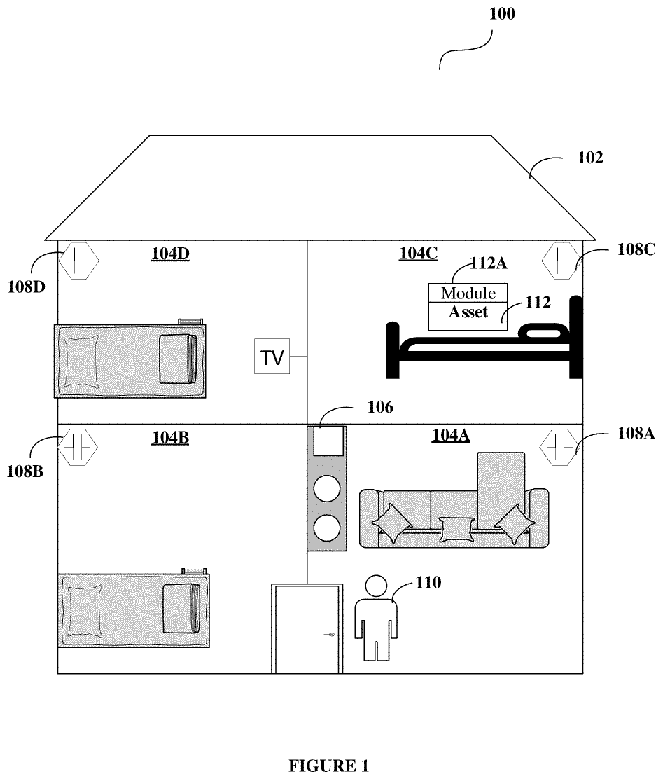

FIG. 1 depicts an exemplary system architecture 100 according to an exemplary embodiment of the invention. As depicted in FIG. 1, a premises 102 may have a first room 104A, a second room 104B, a third room 104C and a fourth room 104D. Also, it can be seen that the first room 104A as well as the second room 104B may be situated at a ground level and the third room 104C as well as the fourth room 104D may be situated at an upper level. Further, the premises 102 may have a plurality of sensors 108 installed in each of the rooms 104. For an instance, a first sensor 108A may be installed in the first room 104A and a second sensor 108B may be installed in the second room 104B. Similarly, a third sensor 108C may be installed in the third room 104C and a fourth sensor 108D may be installed in the fourth room 104D. In an exemplary embodiment, each of the plurality of sensors 104 may be zone sensors. Furthermore, a device 106 may also be installed inside the premises 104. In an exemplary embodiment, the device 106 may be a thermostat. An asset 112 coupled with a module 112A may also be present in the third room 104C of the premises 102. In an exemplary embodiment, the module coupled 112 with the asset 112 may be a tile tracking device, a pebble tracking device, a bluetooth module, a bluetooth module with a smart phone or a smart watch.

In order to locate the asset 112, a user 110 may use the device 106 for raising a request. For this, the user 110 may provide an input via a user interface of the device 106. The input from the user 110 may comprise unique information associated with the asset 112. In an exemplary embodiment, the device 106 may display a list of assets, wherein each of the asset may be coupled with a module and the module may be registered with the device 106. Also, the user 110 may provide the input by selecting an asset from the list of assets displayed on the device 106. An example of a list is as follows: Assets to be tracked: (a) John's Smart Phone; (b) Joe's Watch; (c) Joe's Smart Phone; (d) Joy's Laptop; (e) Joy's Tablet. For an instance, the user 110 may select “John's Smart Phone” asset which the user 110 wishes to locate. Also, the term “John's Smart Phone” may correspond to unique information associated with the asset 112. In another exemplary embodiment, the user 110 may provide a voice input via the user interface of the device 106 to the device 106 to locate the asset. For an example, “please find Joe's Watch” or “Lost Joy's Tablet, please locate it”. The term “Joe's Watch” and “Joy's Tablet” may correspond to unique information associated with the asset 112. In these example, each of the tablet and smart phones (i.e. assets) are coupled with their respective modules.

When the device 106 receives request from the user 110 to locate the asset 112, the device 106 may derive unique identifier from the unique information associated with the asset 112. Each asset 112 may have an associated unique identifier which helps in identifying the asset 112. In an exemplary embodiment, the unique identifier may correspond to a media access control (MAC) address of the asset 112. For an example, each of the unique information “John's Smart Phone”, “Joe's Watch” and “Joy's Tablet” may have its corresponding MAC address. Further, the unique identifier associated with the asset 112 may already be known to the device 106 and may be inputted in the device 106 at the time of the registration.

The device 106 may further transmit a signal to the plurality of sensors 108 to locate the asset 112. The plurality of sensors 108 may be communicably coupled with the device 106. The signal may be sent to the plurality of sensors 108 via a network and may comprise the unique identifier associated with the asset 112. In response to the signal received from the device 106, each of the plurality of sensors 108 may transmit at least one beacon to a module 112A of the asset 112 through the network. In an exemplary embodiment, the at least one beacon may be a bluetooth beacon. The at least one beacon received by the module 112A from each of the plurality of sensors 108 may also comprise the unique identifier associated with the asset 112.

The module 112A of the asset 112 may receive the at least one beacon and in response, the module 112A of the asset 112 may first verify the unique identifier associated with the asset 112. For this, the module 112A may compare the unique identifier received from the plurality of sensors 108 with a unique identifier associated with the asset 112 which may be pre-stored in a memory of the module 112A. After the unique identifier associated with the asset 112 is verified, the module 112A may transmit a communication to each of a corresponding sensor 108 of the at least one beacon either directly or through the network. In an exemplary embodiment, the communication from the module 112A of the asset 112 may be used to derive and may comprise received signal strength indicator (RSSI) value at each sensor 108.

The communication received by the each of the corresponding sensor/s 108 of the at least one beacon from the module 112A may be transmitted to the device 106 for further evaluation (using the RSSI received by the sensor 108). Further, the communication may be transmitted to the device 106 either directly or through the network. When the device 106 receives the communication from the each of the corresponding sensor/s 108, the device may identify a predetermined location of each of the corresponding sensors 108. In an exemplary embodiment, the predetermined location of each of the corresponding sensors 108 may be inputted manually by any user in the device 106. In a different exemplary embodiment, the device 106 may automatically detect the location of the sensors 108 installed in the premises 102.

By evaluating the predetermined location and the communication (i.e. RSSI value in decibels with reference to one milliwatt, dBm), the device 106 may locate the asset 112 and thereby, determine the location of the asset 112. An exemplary Table 1 has been provided below for locating the asset 112 or determining the location of the asset 112. The values in the exemplary Table 1 provided below are only for explanation purpose to enhance the intelligibility of the subject matter.

TABLE 1

| | RSSI Value from | Pre-determined | Location |
|---|---|---|---|
| Sensor | the Module | Location | of Asset |
| Name | 112A (in dBm) | of Sensor | 112 |
| First Sensor, | −75 dBm | Main Room, | Far |
| 108A | | Ground Floor | |
| Second Sensor, | −85 dBm | Bedroom, Ground | Farthest |
| 108B | | Floor | |
| Third Sensor, | −55 dBm | First Bedroom, | Nearest |
| 108C | | First Floor | |
| Fourth Sensor, | −60 dBm | Second Bedroom, | Near |
| 108D | | First Floor | |

As can be seen in Table 1 above, the asset 112 may be located nearest in the first bedroom of first floor with highest RSSI value of −55 dBm of the third sensor 108C. Also, as the third sensor 108C receiving strongest RSSI is in first bedroom, this location information may also be displayed on the device 106 as “the asset is at first bedroom”. Similarly, this can be extended to use trilateration when at-least three RSSI levels are known. Similarly, the asset 112 may be located far from the main room of ground floor with second highest RSSI value of −75 dBm of the first sensor 108A and the asset 112 may be located near to the second bedroom of first floor with RSSI value of −60 dBm of the fourth sensor 108D. Lastly, the asset 112 may be located farthest from the bedroom of ground floor with lowest RSSI value of −85 dBm of the second sensor 108B. Thereby, using the RSSI value from the module 112A along with the pre-determined location of the different sensors, the device 106 may locate the asset 112 in the first bedroom of first floor. In other words, when an asset 112 is close to any of the sensor 108, that particular sensor would receive larger RSSI.

Once the asset 112 is located by the device 106, the device 106 may inform the user 110 regarding the determined location of the asset 112. For an instance as explained in Table 1 above, the device 106 may inform the user 110 that the asset 112 is found at the first bedroom of first floor in the premises 102. In an exemplary embodiment, the device 106 may inform the user 110 regarding the determined location of the asset 112 by outputting a voice command. An example of voice command may be “Your asset is in the first bedroom of first floor”. In an exemplary embodiment, the device 106 may inform the user 110 regarding the determined location of the asset 112 by displaying a message on the user interface of the device 106. An example of a message may be “Your asset is in the first bedroom of first floor”. In an exemplary embodiment, the device 106 may inform the user 110 regarding the determined location of the asset 112 by transmitting a message to a user device or mobile phone of the user 110. For this, the user 110 may need to register the user device or mobile phone with the device 110. In a different embodiment, the device 106 may inform the user 110 regarding the determined location of the asset 112 by providing visual and/or audio directions to the user 110 where the asset 112 is found.

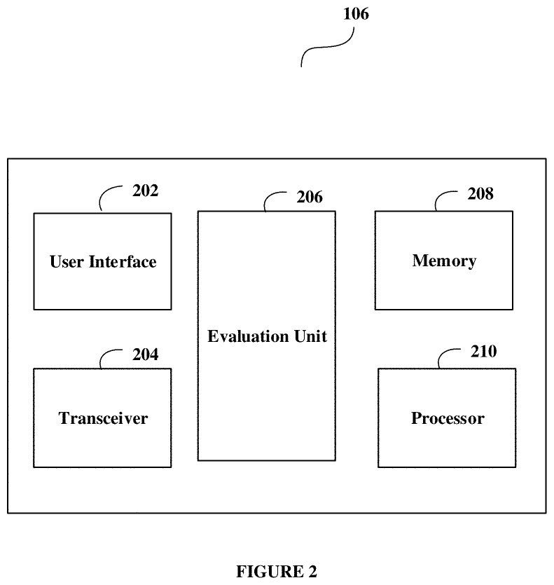

FIG. 2 depicts a block diagram of different components of a device 106 according to an exemplary embodiment of the invention. The device 106 may comprise of, but is not limited to, a user interface 202, a transceiver 204, an evaluation unit 206, a memory 208 and/or a processor 210. The user interface 202 may be configured to receive a request from a user 110 to locate an asset 112 inside a premises 102. The user interface 202 may communicate the request to the transceiver 204. Further, the transceiver 204 may be configured to transmit a signal to a plurality of sensors 108 for locating the asset 112 through a network. The transceiver 204 may also be configured to receive a communication from the plurality of sensors 108 as described in FIG. 1 above. The transceiver 204 may communicate the communication to the evaluation unit 206. The evaluation unit 206 may be configured to evaluate the communication to determine the location of the asset 112 as described in FIG. 1 and Table 1 above. The transceiver 204 may be adapted to inform the user 110 regarding the determined location of the asset 112. The memory 208 may be adapted to store the unique identifier associated with the asset 112, identifier of the plurality of sensors 108, the RSSI value etc.

Moreover, the user interface 202, the transceiver 204, the evaluation unit 206, the memory 208 may be communicably coupled with the processor 210. The different units described herein are exemplary. The invention may be performed using one or more units. For example, the tasks executed by the user interface 202, the transceiver 204, the evaluation unit 206, the memory 208 and/or the processor 210 may be performed by a single unit. Alternatively more number of units as described herein may be used to perform the present invention.

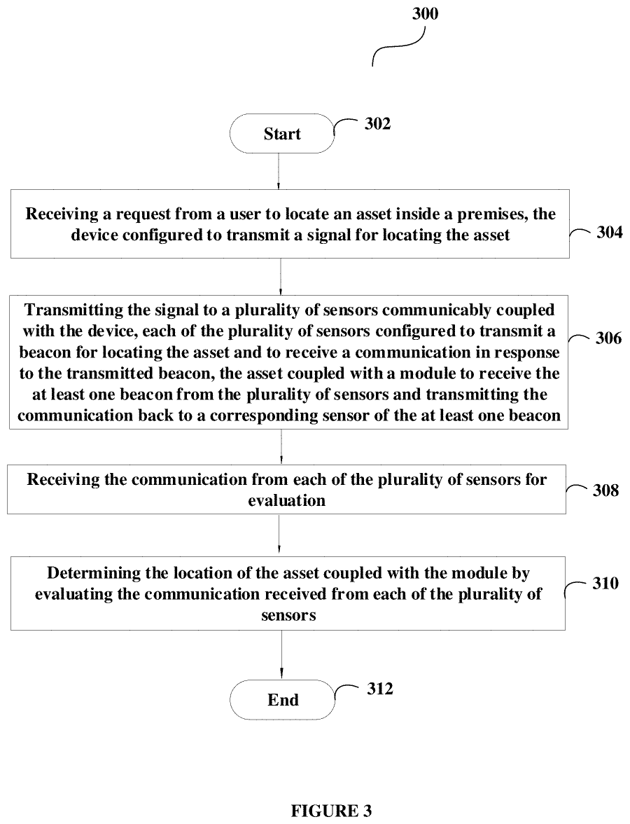

FIG. 3 depicts a flowchart outlining the features of the invention in an exemplary embodiment of the invention. The method flowchart 300 describes a method being for determining location of an asset 112. The method flowchart 300 starts at step 302.

At step 304, a device 106 may receive a request from a user 110 to locate an asset 112 inside a premises 102. Also, the device 106 may be configured to transmit a signal to locate the asset 112. This has been discussed above in FIG. 1 in greater details.

At step 306, the device 106 may transmit the signal to the plurality of sensors 108 communicably coupled with the device 106. Also, each of the plurality of sensors 108 may be configured to transmit at least one beacon for locating the asset 112 and to receive a communication in response to the transmitted beacon. Further, the asset 112 coupled with a module 112A to receive the at least one beacon from the plurality of sensors 108 and transmit the communication back to a corresponding sensor 108 of the at least one beacon. This has been discussed above in FIG. 1 in greater details.

At step 308, the device 106 may receive the communication from each of the plurality of sensors 108 for evaluation. This has been discussed above in FIG. 1 in greater details.

At step 310, the device 106 may determine the location of the asset 112 coupled with the module 112A by evaluating the communication received from each of the plurality of sensors 108. This has been discussed above in FIG. 1 in greater details. Then, the method flowchart 300 may end at 312.

The present invention is applicable to various fields/industries such as, but not limited to, hospitality industry, real-estate industry, hostels, educational institutes, banking sector, automobile industry, and any such field/industry where the device 106 and the plurality of sensors 108 can be used and is obvious to a person skilled in the art.

In one embodiment of the invention, the invention can be operated using the one or more computer readable devices. The one or more computer readable devices can be associated with a device 106. A computer readable medium comprises one or more processors and a memory coupled to the one or more processors, the memory stores instructions executed by the one or more processors. The one or more processors configured to receive a request from a user 110 to locate an asset 112 inside a premises 102. Also, the device 106 may be configured to transmit the signal to the plurality of sensors 108 communicably coupled with the device 106. Each of the plurality of sensors 108 may be configured to transmit a beacon for locating the asset 112 and to receive a communication in response to each of the transmitted beacon. Further, the asset 112 coupled with a module 112A to receive the at least one beacon from the plurality of sensors 108 and transmit the communication back to a corresponding sensor 108 of the at least one beacon. The one or more processors configured to receive the communication from each of the plurality of sensors 108 for evaluation and to determine the location of the asset 112 coupled with the module 112A by evaluating the communication received from each of the plurality of sensors 108.

Exemplary computer readable media includes flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Computer storage media for purposes of this invention are not signals per se. Exemplary computer storage media include hard disks, flash drives, and other solid-state memory. In contrast, communication media typically embody computer readable instructions, data structures, program modules, or other data in a modulated data signal such as a carrier wave or other transport mechanism and include any information delivery media.

Although described in connection with an exemplary computing system environment, examples of the invention are capable of implementation with numerous other general purpose or special purpose computing system environments, configurations, or devices.

Examples of the invention may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the Figures/Tables and described herein. Other examples of the invention may include different computer-executable instructions or components having more or less functionality than illustrated and described herein. Aspects of the invention transform a general-purpose computer into a special-purpose computing device when configured to execute the instructions described herein.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A system comprising:
a device configured to receive a request from a user to locate an asset inside a premises, the device further configured to transmit a signal for locating the asset;
a plurality of sensors communicably coupled with the device, each of the plurality of sensors configured to:
receive the signal from the device;
transmit a beacon in response to the received signal;
receive a communication in response to the transmitted beacon; and
transmit the communication to the device for evaluation;
the asset coupled with a module configured to receive the at least one beacon from the plurality of sensors and to transmit the communication back to a corresponding sensor of the at least one beacon; and
the device further configured to evaluate the communication to determine the location of the asset.

2. The system according to claim 1, wherein the request comprises receiving input from the user via a user interface.

3. The system according to claim 2, wherein the device is a thermostat and the plurality of sensors correspond to zone sensors installed inside the premises.

4. The system according to claim 2, wherein the input from the user comprises unique information associated with the asset.

5. The system according to claim 4, wherein the transmission of the signal from the device comprises a unique identifier associated with the asset, wherein the unique identifier is derived from the unique information.

6. The system according to claim 5, wherein the beacon transmitted by each of the plurality of sensors comprises the unique identifier associated with the asset, wherein the at least one beacon of the plurality of beacons is received by the module associated with the asset.

7. The system according to claim 6, wherein on receiving the at least one beacon, the module verifies the unique identifier and further sends the communication to the corresponding sensor of the at least one beacon.

8. The system according to claim 1, wherein the communication received by each of the corresponding sensors comprises a received signal strength indicator (RSSI) value.

9. The system according to claim 8, wherein the RSSI value received from each of the corresponding sensors and predetermined location of each of the corresponding sensors is used by the device to determine location of the asset.

10. The system according to claim 1, wherein the module coupled with the asset is a tile tracking device, a pebble tracking device, a bluetooth module or a bluetooth module with a smart phone or a smart watch.

11. A method comprising:
receiving a request from a user to locate an asset inside a premises, the device configured to transmit a signal for locating the asset;
transmitting the signal to a plurality of sensors communicably coupled with the device, each of the plurality of sensors configured to transmit a beacon for locating the asset and to receive a communication in response to the transmitted beacon, the asset coupled with a module to receive the at least one beacon from the plurality of sensors and transmitting the communication back to a corresponding sensor of the at least one beacon;
receiving the communication from each of the plurality of sensors for evaluation; and
determining the location of the asset coupled with the module by evaluating the communication received from each of the plurality of sensors.

12. The method according to claim 11, the request comprises receiving input from the user via a user interface.

13. The method according to claim 12, wherein the device is a thermostat and the plurality of sensors correspond to zone sensors installed inside the premises.

14. The method according to claim 12, wherein the input from the user comprises unique information associated with the asset.

15. The method according to claim 14, wherein the transmission of the signal from the device comprises a unique identifier associated with the asset, wherein the unique identifier is derived from the unique information.

16. The method according to claim 15, wherein the beacon transmitted by each of the plurality of sensors comprises the unique identifier associated with the asset, wherein the at least one beacon of the plurality of beacons is received by the module associated with the asset.

17. The method according to claim 11, wherein the communication received by each of the corresponding sensors comprises RSSI value, wherein the RSSI value received from each of the corresponding sensors and predetermined location of each of the corresponding sensors is used by the device to determine location of the asset.

18. The method according to claim 16, wherein on receiving the at least one beacon, the module verifies the unique identifier and further sends the communication to the corresponding sensor of the at least one beacon.

19. The method according to claim 11, wherein the module coupled with the asset is a tile tracking device, a pebble tracking device, a bluetooth module or a bluetooth module with a smart phone or a smart watch.

20. A computer readable medium comprising one or more processors and a memory coupled to the one or more processors, the memory storing instructions executed by the one or more processors, the one or more processors configured to:
receive a request from a user to locate an asset inside a premises, the device configured to transmit a signal for locating the asset;
transmit the signal to a plurality of sensors communicably coupled with the device, each of the plurality of sensors configured to transmit a beacon for locating the asset and to receive a communication in response to each of the transmitted beacon, the asset coupled with a module to receive the at least one beacon from the plurality of sensors and transmit the communication back to a corresponding sensor of the at least one beacon;
receive the communication from each of the beacon for evaluation; and
determine the location of the asset coupled with the module by evaluating the communication received from each of the plurality of sensors.
